(19) United States
(12) Patent Application Publication
(10) Pub. No.: US 2005/0028159 A1
(43) Pub. Date: Feb. 3, 2005

(54) Memory managing system and task controller in multitask system

(76) Inventors: Masayoshi Kodama, Osaka (JP); Keita Kobayashi, Osaka (JP)

Correspondence Address: MCDERMOTT WILL & EMERY LLP, 600 13TH STREET, N.W., WASHINGTON, DC, 20005-3096, US

(21) Appl. No.: 10/766,952

(22) Filed: Jan. 30, 2004

(30) Foreign Application Priority Data
Jul. 30, 2003 (JP) P. 2003-282887

(51) Int. Cl. G06F 9/46

(52) U.S. Cl. 718/100

(57) ABSTRACT

When an interrupt is generated during the operation of an idle task, after the value of a CPU register is stored in a current stack area, and then, the current stack area is switched to a stack area exclusively used for processing an interrupt. At this time, stacks have a structure in which the stack area is superposed on the stack area exclusively used for processing the interrupt. When the interrupt is generated during an idle process, the stack for processing the interrupt is used so as to overwrite the area in which the value of the CPU register is stored. Thus, an amount of use of RAM is reduced by commonly using a stack used in an interrupt process with a stack used in an idle process in a multitask system.

### BACKGROUND OF THE INVENTION

The present invention relates to a managing method of a stack memory of software, and more particularly to a program structure for reducing an available amount of the stack memory when a multitask system is executed.

With the progress of the complication of a control in a program, a multitask system that can process two or more tasks respectively as units of jobs by a computer at one time has been ordinarily employed. The use of the multitask system makes it possible to efficiently switch and execute a plurality of tasks.

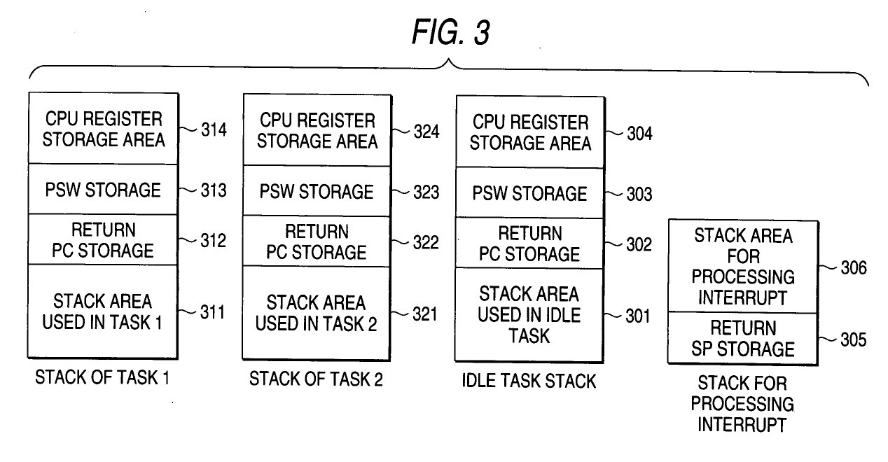

FIG. 3 schematically shows one example of a using state of a RAM in a usual multitask system. Areas designated by reference numbers in FIG. 3 show stack memory areas (refer them to as stacks, hereinafter) used in respective tasks. Specifically, on the RAM, a plurality of stack shaving a plurality of task 1, task 2, . . . , and task n, a stack for an idle task, and a stack exclusively used for processing an interrupt executed by the multitask system are constructed.

The stacks are respectively composed of stacks 301, 311 and 321, return PC storage areas 302, 312 and 322, PSW storage areas 303, 313 and 323 and CPU register storage areas 314, 324 and 304. Further, the stack for processing the interrupt includes a return SP storage area 305 for storing a task SP upon generation of an interrupt and a stack area 306 for processing an interrupt used in an interrupt processing sequence.

Here, the interrupt process indicates a process performed every prescribed time under the control of, for instance, a timer by temporarily interrupting a task (ordinary process) when this task is performed or a process performed by an external factor.

For instance, when the interrupt is generated during the operation of the task 1, the task 1 performed by using the stack 311 is temporarily interrupted. At this time, a current value of a PC register is stored in the return PC storage area 312. A current value of a PSW register is stored in the PSW storage area 313. Further, the value of a CPU register used in the task 1 is stored in the CPU register storage area 314. Then, the value of an SP register of the task 1 is stored in the return SP storage area 305 in the stack area used for processing the interrupt. The value of the SP register is set so as to point a boundary of the return SP storage area 305 and the stack area 306 used for processing the interrupt, that is, the bottom area of the stack area 306. Thus, the stack area is switched from the task stack to the stack for processing the interrupt.

When the interrupt process is completed, the value stored in the SP storage area 305 is set to the SP register to switch the stack area to the task stack. After that, the value stored in the CPU register storage area 314 is set to each CPU register and the values stored in the PSW storage area 313 and the return PC storage area 312 are also returned to the PSW register and the PC register so that the stack area can be returned to the original task 1. In such a structure, while the plural tasks are performed by the multitask system, a prescribed interrupt process can be performed (for example, refer to Patent Document 1)
[Patent Document 1] JP-A-8-123698

However, in the stack structure shown in FIG. 3, the relief capacities of the CPU registers to be stored upon generation of the interrupt are mainly determined irrespective of the contents of processing of tasks. Many registers that do not need to store data may be possibly included therein so that memories are unnecessarily consumed. To meet this, there is a method in which kinds of the CPU registers in which data is to be stored are discriminated in the first part of, for instance, the interrupt process. However, this method disadvantageously has a problem that an interrupt response performance is deteriorated.

### SUMMARY OF THE INVENTION

The present invention solves the above-described problems and comprises n task stacks for executing a multitask system, a stack for processing an interrupt shared to function by each of the n task stacks and PC, PSW and CPU registers respectively shunted to task stacks executed when the interrupt process is generated. The stack area for processing the interrupt is shared and used by any one task stack of the n task stacks. When the interrupt process is generated, after the values of the PC, PSW and CPU registers are shunted to the current task stack, a stack pointer is switched to an interrupt process side. When the interrupt process is completed, after the stack pointer is switched to the task stack, the values of the PC, PSW and CPU registers stored on the task stack are returned from the task stack to resume the operation of the task.

As described above, as effects of the present invention, a task stack area of a system using an OS of real time and an interrupt stack area are simultaneously used in a duplicated manner so that an available amount of a memory can be reduced in all the system. Accordingly, the multitask system can be advantageously operated by the memory of small capacity.

### BRIEF DESCRIPTION OF THE PREFERRED EMBODIMENTS

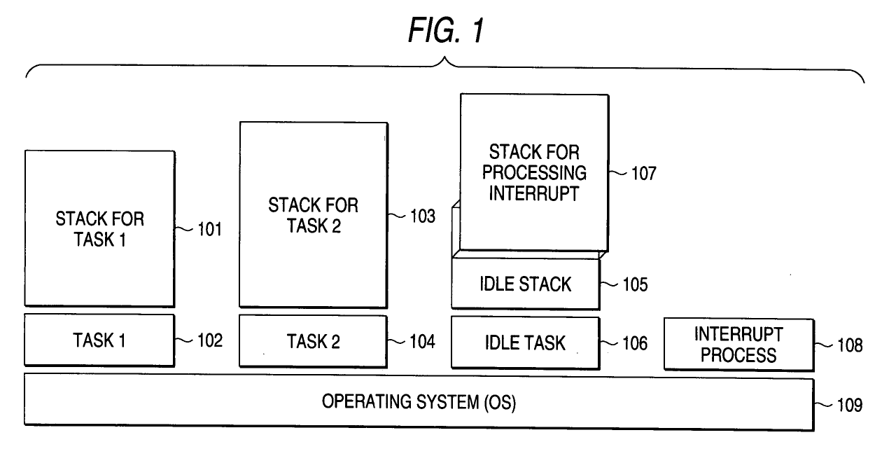

FIG. 1 is a diagram schematically showing a stack structure of an embodiment of the present invention.

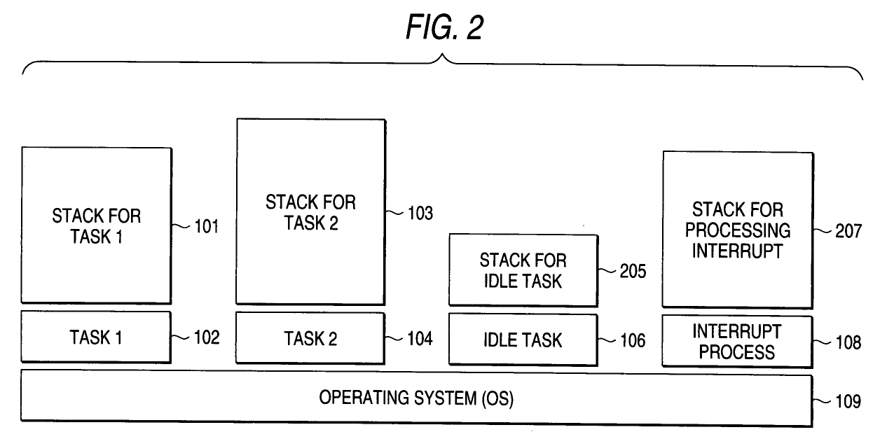

FIG. 2 is a diagram schematically showing a stack structure in a usual multitask system.

FIG. 3 is a diagram specifically showing the using state of stacks in a usual multitask system.

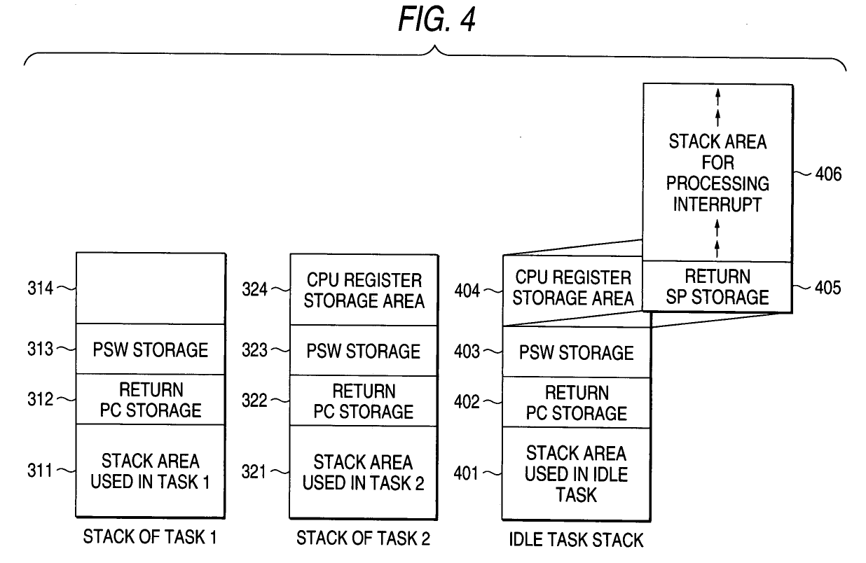

FIG. 4 is a diagram specifically showing the using state of stacks in a multitask system of the present invention.

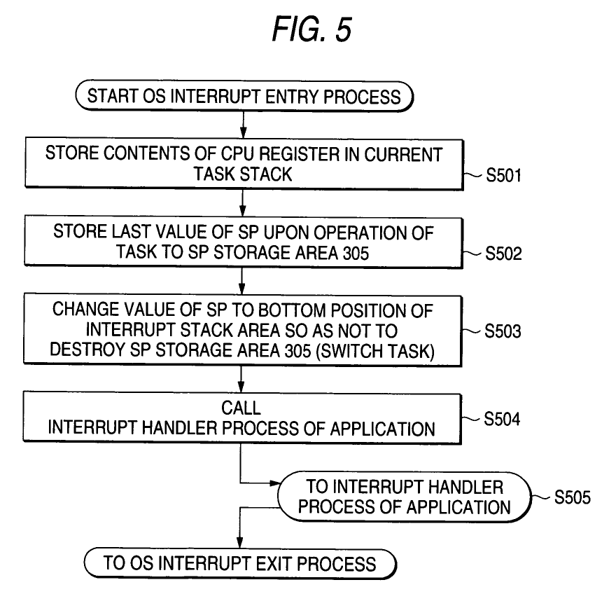

FIG. 5 is a flow chart showing the contents of a stack switching process upon generation of an interrupt in the usual multitask system.

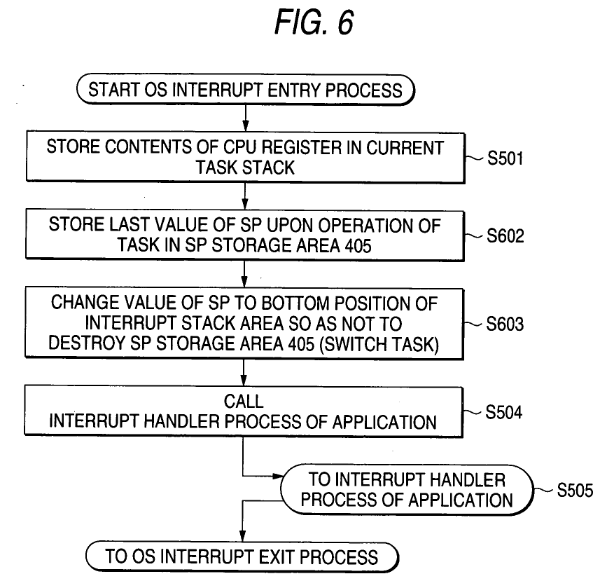

FIG. 6 is a flow chart showing the contents of a stack switching process upon generation of an interrupt in the multitask system of the present invention.

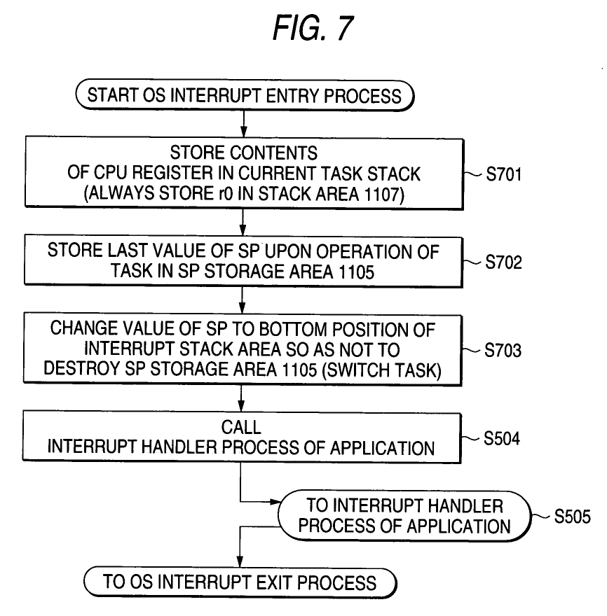

FIG. 7 is a flow chart showing the contents of a stack switching process when a mode is shifted to a low power consumption operating mode of the present invention.

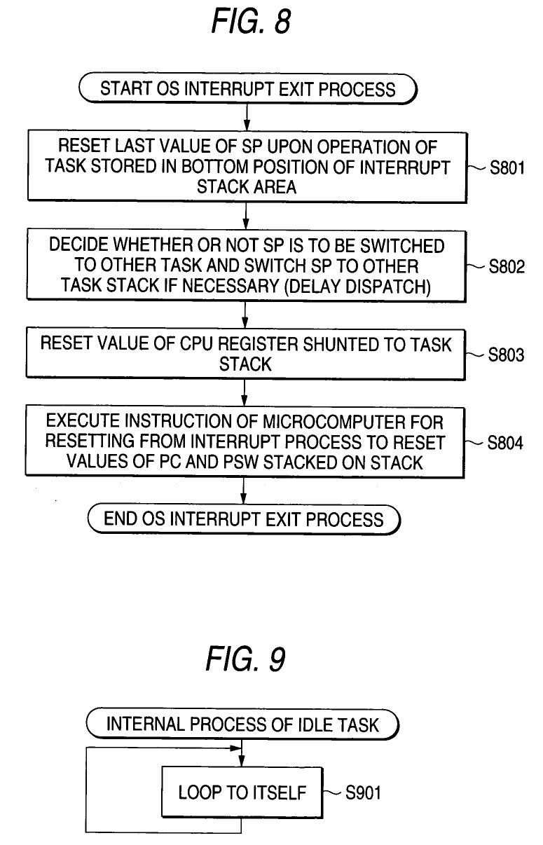

FIG. 8 is a flow chart showing the contents of a stack switching process upon completion of an interrupt.

FIG. 9 is a flow chart showing the contents of an idle task process in the case of an empty loop.

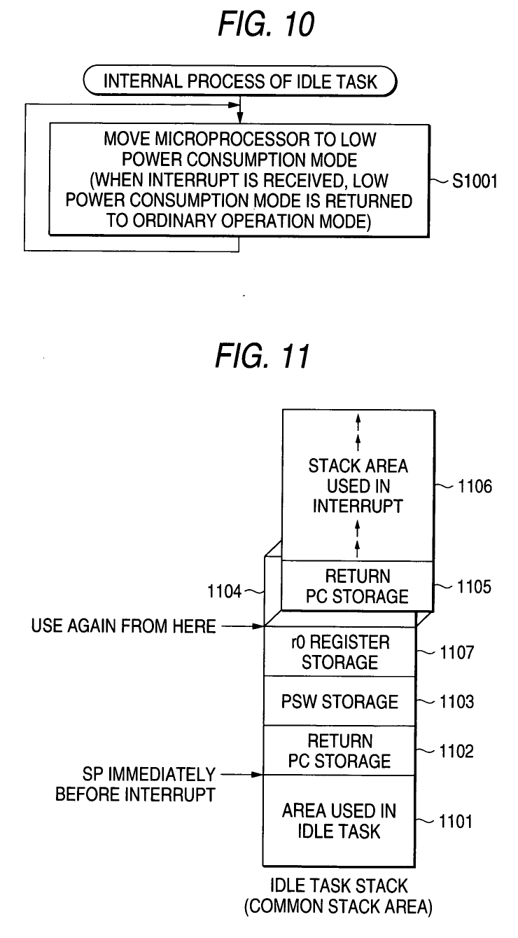

FIG. 10 is a flow chart showing the contents of the idle task process when a mode is moved to the low power consumption operating mode.

FIG. 11 is a diagram specifically showing the structure of a stack for an idle task and a stack for processing an interrupt when a mode is moved to the low power consumption operating mode.

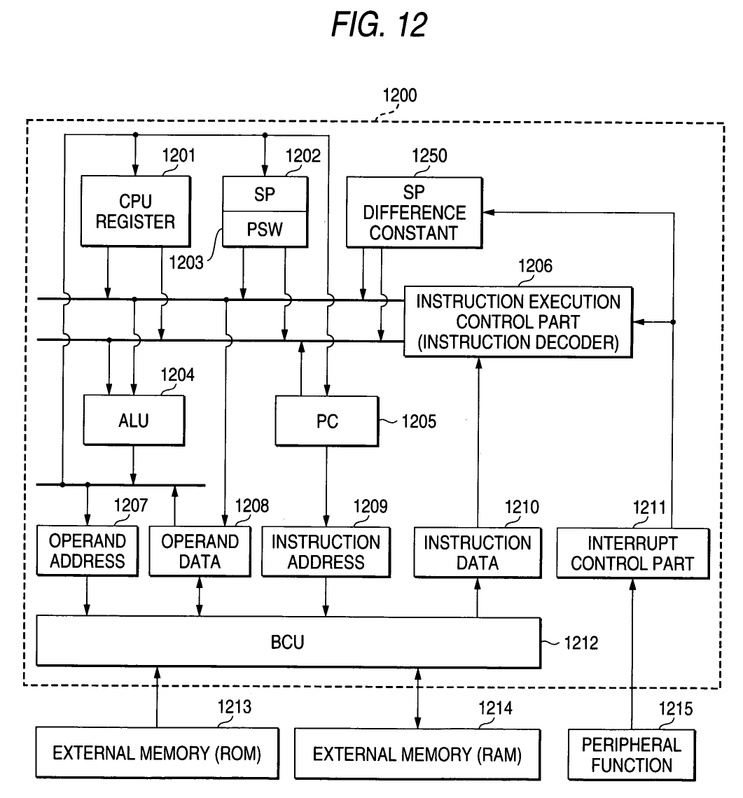

FIG. 12 shows a task controller in first and second embodiments.

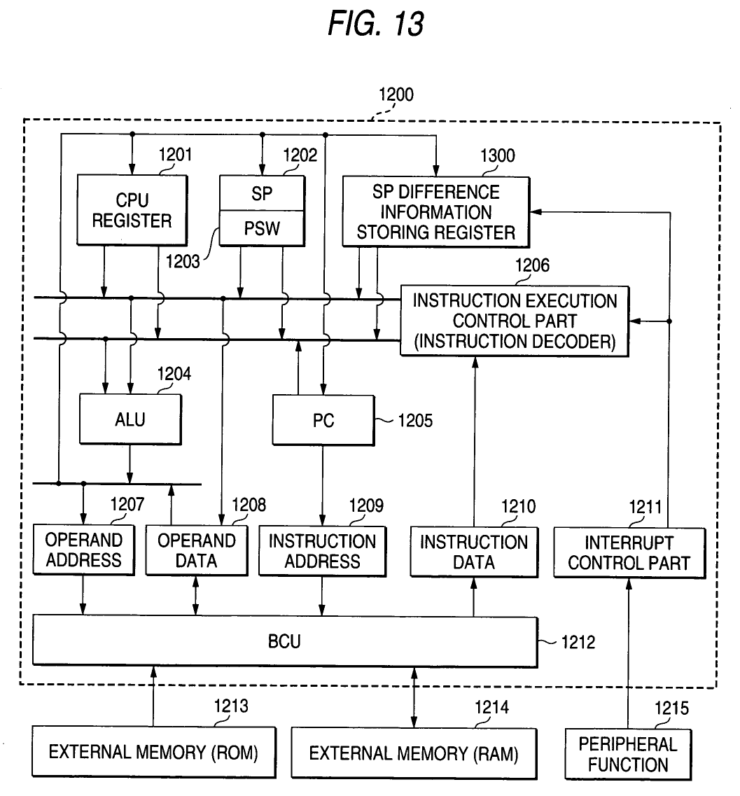

FIG. 13 shows a task controller in a third embodiment.

### DETAILED DESCRIPTION OF THE PREFERRED EMBODIMENTS

Now, embodiments of the present invention will be described below by referring to the drawings.

(First Embodiment)

FIG. 1 is a diagram showing a way of use of stacks in a multitask system according to the present invention. This multitask system is more characteristic than a usual multitask system shown in FIG. 2 in view of a place where a stack 107 for processing an interrupt is disposed.

In the usual multitask system shown in FIG. 2, three tasks 102, 104 and 106 and one interrupt processing program 108 operate on an operating system (refer it to as an OS, hereinafter) 109. Stack areas 101, 103, 205 and 207 are independently prepared respectively for the tasks or the program. The task with the lowest priority of the three tasks is called an idle task 106. When this idle task operates, this shows a state that there is no task to be processed by the system and an entry of an external interrupt request is waited for.

In the multitask system according to the present invention shown in FIG. 1, three tasks 102, 104, and 106 and one interrupt processing program 108 also operate on an OS 109 and stack areas 101, 103, 105 and 107 are independently prepared respectively for the tasks or the program. Further, the idle task 106 with the lowest priority of the three tasks is also prepared. In this case, the stack 107 for processing the interrupt is disposed so as to be superposed on the stack area 105 for the idle task. The stack area upon interrupt process operates by overwriting (stack destruction) the stack area used in an idle task process.

FIG. 3 shows the contents of stacks which include two ordinary task stack areas, one stack area for an idle task and one stack area for processing an interrupt in a usual multitask system

In FIG. 3, initially, when a task 1 operates, a stack pointer (refer it to as an SP, hereinafter) points a stack area 311 for the task 1 and the task 1 uses this area to process a program. Under this state, when an interrupt is generated and a CPU receives the interrupt, the contents of a program counter (refer it to as a PC, hereinafter) and a processor status word (refer it to as a PSW, hereinafter) are respectively stored in stack areas 312 and 313, in view of hardware. The value of the SP is automatically subtracted by the sizes of the PC and the PSW. Then, the CPU moves the value of the PC to the first position of an interrupt processing program to execute an OS interrupt entry process.

FIG. 5 shows a flow chart of the OS interrupt entry process when the interrupt is received during the operation of the task in the usual multitask system. A case that the interrupt is generated during the operation of the task 1 will be described below. Initially, in step S501, the value of a CPU register is stored in a stack area 314. The number of the CPU registers is different depending on the kinds of CPUs. The simplest mounting method is that all the CPU registers mounted on the CPU are stored. Then, in step S502, the current value of the SP (this is equal to the last address of a relevant task stack) is stored in a return SP storage area 305 located at the bottom position of a stack area for processing an interrupt. This process is a process necessary for returning again a position pointed by the SP to the task stack upon completion of the interrupt process. Then, in step S503, the bottom address of a stack area 306 for processing the interrupt is substituted for the SP to switch the stack from a task stack area 314 to the stack area 306 for processing the interrupt. At this time, an attention is paid to set the value of the SP so that the return SP storage area 305 to the task is not overwritten. Finally, in step S504, an interrupt handler function defined by an application is called to execute the interrupt handler program of the application in step S505. The process returns to the OS interrupt entry process from the step S505 in the form of a function return to shift to an OS interrupt exit process after that.

FIG. 8 is a flow chart of the OS interrupt exit process when the interrupt process is completed to return to the task. In the OS interrupt exit process, the value stored in the return SP storage area 305 to the task is initially returned to the SP in step S801. Thus, the stack area 306 for processing the interrupt is kept unused. In an ordinary OS, a delay dispatch process is performed in step S802. The delay dispatch process is carried out as described below. When the process is returned to the task from the interrupt process, it is decided whether or not the task needs to be switched. Then, when the task needs to be switched, the value of the SP is changed so as to point a suitable stack address of another task (for instance, a task 2) from the current task 1. In the present invention, since the contents of the delay dispatch process do not constitute the main subject of the present invention, they are not especially referred to. In step S803, the value of the CPU register stored in the step S501 is returned to each CPU register from the stack area 314. Finally, in step S804, the process is returned to the task process interrupted by the interrupt. At this time, an instruction for returning the process from the interrupt process prepared by the CPU is executed to reset the contents of the PC and the PSW from the stack.

The steps in which the interrupt is received during the operation of the task to return the process to the task via the exit process from the OS interrupt entry process are completely the same as those of a task 2 or an idle task shown in FIG. 3. The above-described task 1 may not be used. That is, the stack areas 311 to 314 used by the task 1 in FIG. 3 may be directly replaced by stack areas 321 to 324, or stack areas 301 to 304.

FIG. 4 is a diagram showing the contents of stacks including two ordinary task stack areas and one stack area for an idle task in a multitask system according to the present invention.

In FIG. 4, initially, when a task 1 operates, an SP points a stack area 311 for the task 1 and the task 1 uses this area to process a program. Under this state, when an interrupt is generated and a CPU receives the interrupt, the contents of a PC and a PSW are respectively stored in stack areas 312 and 313, in view of hardware. At this time, the value of the SP is automatically subtracted by the sizes of the PC and the PSW. Then, the CPU moves the value of the PC to the first position of an interrupt processing program to execute an OS interrupt entry process.

FIG. 6 shows a flow chart of the OS interrupt entry process when the interrupt is received during the operation of the task. Initially, in step S501, the value of a CPU register is stored in a stack area 314. The number of the CPU registers is different depending on the kinds of CPUs. The simplest mounting method is that all the CPU registers mounted on the CPU are stored. Then, in step S602, the current value of the SP (this is equal to the last address of a relevant task stack) is stored in a return SP storage area 405 located at the bottom position of a stack area for processing an interrupt. This process is a process necessary for returning again a position pointed by the SP process to the task stack upon completion of the interrupt process. Here, an attention is to be directed to a fact that the return SP storage area 405 is superposed on a CPU register storage area 404 of an idle task, which is different from the usual multitask system shown in FIG. 5. Then, in step S603, the bottom address of a stack area 406 for processing the interrupt is substituted for the SP to switch the stack from a task stack to the stack exclusively used for processing the interrupt. At this time, an attention is paid so that the return SP storage area 405 to the task is not overwritten. Finally, in step S504, an interrupt handler function defined by an application is called to execute the interrupt handler program of the application in step S505. The process shifts to an OS interrupt exit process from the step S505 in the form of a function return. The OS interrupt exit process is the same process described in the related art by referring to FIG. 8. Thus, a detailed description thereof is omitted.

Here, the steps in which the interrupt is received during the operation of the task to return the process to the task via the OS interrupt exit process from the OS interrupt entry process are completely the same as those of the task 2 shown in FIG. 4. The above-described task 1 may not be used. That is, the stack areas 311 to 314 used by the task 1 shown in FIG. 4 may be directly replaced by stack areas 321 to 324.

However, in the case of stack areas used in an idle stack, conditions are different. In the usual multitask system, the stack areas 301 to 304 used by the idle task can be directly replaced by the stack areas 311 to 314 of the task 1. However, in the present invention, since the stack area 404, the return SP storage area 405 and the stack area 406 for processing the interrupt shown in FIG. 4 are disposed so as to be superposed, an attention needs to be paid. Now, an operation when an interrupt is received while the idle task operates will be specifically described below.

Firstly, when the idle task operates, the SP points an address in an idle task stack area 401. The idle task uses this area to process a program (however, this area is not necessarily present to have zero byte sometimes). Under this state, when the interrupt is generated and the CPU receives the interrupt, the contents of a PC and a PSW are respectively stored in a PC storage area 402 and a PSW storage area 403 in view of hardware. Here, the value of the SP is automatically subtracted by the sizes of the PC and the PSW. That is, if the PC and the PSW respectively have 4 bytes, the stack consumes 8 bytes for storing them. This is the same as that the SP is subtracted by 8 bytes. Then, the CPU moves the value of the PC to the first address of an interrupt processing program to execute an OS interrupt entry process. The OS interrupt entry process when the interrupt is received upon operation of the idle task operates in accordance with the flow chart shown in FIG. 6.

On the other hand, the OS interrupt exit process is the same process as the related art described by referring to FIG. 8. However, since the value of the CPU register reset in the step S803 is already overwritten, an attention needs to be paid to a fact that the value is different from the value stored upon OS interrupt entry process.

FIG. 9 is a flow chart showing the operation of the idle task according to the first embodiment. As shown in FIG. 9, the idle task in the first embodiment is mounted so as to be formed by a self-endless loop S901. Accordingly, even when all the CPU registers except the PC and the PSW are overwritten to indeterminate values within the interrupt process in the step S803 shown in FIG. 8, the program of the idle task operates without using the CPU register. Thus, no problem is generated after the interrupt is reset.

FIG. 12 shows a task controller for realizing the above-described multitask system according to the present invention. In the task controller, a PC 1205 points the instruction address 1209 of a currently executed program. This value obtains instruction data 1210 from an external memory (ROM) 1213 through a bus control unit (refer it to as a BCU, hereinafter) 1212. The instruction data 1210 is decoded in an instruction execution control part 1206 to determine the entire operation of the task controller 1200 in accordance with the kind of the decoded instruction. When the instruction data is an instruction to write data in the external memory, the instruction execution control part 1206 reads a necessary address value from a CPU register 1201 to deliver the address value to a calculation unit (refer it to as an ALU, hereinafter) 1204. The instruction execution control part delivers an operand address 1207 to an external memory (RAM) 1214 via the BCU 1212 as address data. The instruction execution control part simultaneously reads operand data 1208 in the CPU register 1201 to write the data in the external memory (RAM) 1214 via the BCU 1212. The task controller has an interrupt control part 1211 mounted thereon and has a function for receiving an interrupt request from a peripheral function 1215 and informing the instruction execution control part 1206 of the interrupt request and interrupting the currently executed program.

Further, the task controller has an SP difference constant 1250 for controlling a stack address upon interrupt process. When an interrupt is generated during the operation of a certain task, the value of an SP 1202 is supplied to the external memory (RAM) 1214 via the operand address 1207 and the BCU 1212 as the address of a task stack. After the values of the PC 1205 and a PSW 1203 are stored in the task stack, the value of the SP is updated by the values thereof. Subsequently, the contents of the CPU register are stored in the task stack as shown in the flow chart of FIG. 6 to update the value of the SP by the contents thereof.

Then, the final value of the SP 1202 is stored in the return SP storage area 405 of the stack for processing the interrupt. To the OS interrupt entry processing program or the interrupt control part 1211, the first address of the CPU register storage area 404 of the idle task stack is previously given as a destination on which the stack for processing the interrupt is superimposed. To the SP difference constant 1250, the address difference value of the first address of the stack for processing the interrupt relative to the first address of the CPU register storage area 404 of the idle task stack is given.

The destination on which the stack for processing the interrupt is superimposed, that is, the first address of the CPU register storage area of the idle task stack is supplied from the OS interrupt entry processing program or the interrupt control part 1211. The first address and the value of the SP difference constant 1250 are calculated in the ALU 1204. The calculated value is supplied to the external memory (RAM) 1214 via the operand address 1207 and the BCU 1212 as an address to store the final value of the SP. Here, in this embodiment, 0 is supplied to the SP difference constant 1250. Thus, the first address of the return SP storage area 405 of the stack for processing the interrupt is allowed to correspond to the first address of the CPU register storage area of the idle task stack. The first address is updated by a part of the SP storage area to set to the SP. Thus, the stack for processing the interrupt can be used to advance the interrupt process forward.

As described above, the stack for processing the interrupt is superimposed on the task stack of the idle task, so that the unused CPU register storage area of the task stack of the idle task can be effectively utilized.

(Second Embodiment)

The multitask system described in the first embodiment of the present invention can be realize in an idle task including another process as shown in a flow chart of FIG. 10 as well as the idle task only including the simple endless loop as shown in FIG. 9. In FIG. 10, as shown in step S1001, an idle task program performs a process for shifting the operation mode of a CPU to a low power consumption mode. Here, after the CPU shifts the low power consumption mode, a subsequent instruction is not executed until an interrupt is received. When an interrupt requests enters the CPU and the low power consumption mode is released, the CPU returns to an ordinary operation mode and executes an OS interrupt entry process shown in a flow chart of FIG. 7.

When the operation mode of the CPU is shifted to the low power consumption mode, an r0 register as one of CPU registers is used. In this case, the value of the r0 register needs to be stored even before and after an interrupt process.

FIG. 11 shows a method for using an idle stack and a stack for processing an interrupt in this case. Firstly, when an idle task operates, an SP points a stack area 1101 for the idle task. The idle task uses this area to process a program. While the above-described program uses the r0 register, when an interrupt is generated and the CPU receives the interrupt, the contents of a PC and a PSW are respectively stored in stack areas 1102 and 1103 in view of hardware. At this time, the value of the SP is automatically subtracted by the sizes of the PC and the PSW. Then, the CPU moves the value of the PC to the first address of an interrupt processing program to execute the OS interrupt entry process shown in FIG. 7.

In the OS interrupt entry process shown in FIG. 7, in step S701, the values of the CPU registers are firstly stored in stack areas 1107 and 1104. In this case, in the step S701, the value of the r0 register is necessarily stored in the r0 register storage area 1107 located just above the PSW storage area 1103. Other CPU registers may be stored at any place irrespective of order. Then, in step S702, the current value of the SP is stored in the bottom position 1105 of a stack area for processing an interrupt. The return SP storage area 1105 needs to be located at a position where the r0 register storage area 1107 is not overwritten, which is different from the first embodiment. However, the return SP storage area is disposed so as to be superposed on the CPU register storage area 1104 for storing other CPU registers except the r0 register. In step S703, the SP is replaced by the bottom address of a stack area 1106 for processing an interrupt to switch the stack to the stack area 1106 for processing the interrupt from the idle task stack. The stack area 1106 for processing the interrupt is superposed on the above-described CPU register storage area 1104. Thus, the value of the CPU register stored in the stack area 1104 is overwritten like the case of the first embodiment. Finally, in step S504, an interrupt handler function defined by an application is called to execute the interrupt handler program of the application in step S505. The process shifts to an OS interrupt exit process shown in FIG. 8 from the step S505 in the form of a function return.

On the other hand, the OS interrupt exit process is the same process as the related art described by referring to FIG. 8. However, since the value of the CPU register reset in the step S803 is already overwritten except the r0 register storage area 1107, an attention needs to be paid to a fact that the value is different from the value stored upon OS interrupt entry process. As the value of the r0 register, the correct value stored in the r0 register storage area 1107 is reset. The originally generated interrupt is received while the r0 register is used in the idle task. After the idle task program is reset from the interrupt, the idle task program can use the contents of the r0 register to move the CPU to the low power consumption mode.

In the above description, the OS interrupt entry process when the interrupt is generated during the operation of the idle task is explained. However, since the stack for processing the interrupt is superimposed on the idle task stack, when the interrupt is generated while an arbitrary task is executed, the same processes as those described in the first embodiment are carried out in the OS interrupt entry process. That is, the contents of the CPU register of the task in which the interrupt is generated are stored in the task stack, and then, the final value of the SP 1202 is stored in the return SP storage area 1105 of the stack for processing the interrupt.

Thus, the destination on which the stack for processing the interrupt is superimposed, that is, the first address of the CPU register storage area of the idle task stack is supplied from the OS interrupt entry processing program or the interrupt control part 1211. The first address and the value of the SP difference constant 1250 are calculated in the ALU 1204. The calculated value is supplied to the external memory (RAM) 1214 via the operand address 1207 and the BCU 1212 as an address to store the final value of the SP. Here, in this embodiment, a value in which the shunt part of the r0 register storage area 1107 is taken into account is supplied to the SP difference constant 1250 as an address difference value. As a result, the first address of the SP storage area 1105 of the stack for processing the interrupt can be determined as a next address of the shunt area of the r0 register storage area 1107 in the idle task stack.

As described above, the stack for processing the interrupt is super imposed on the task stack of the idle task. Accordingly, even when a part of the CPU register is used in the idle task, the unused CPU register storage area of the task stack of the idle task can be effectively utilized.

(Third Embodiment)

The first embodiment and the second embodiment are described by noticing the idle task. However, when the CPU register used by the task is clearly recognized, the same method may be applied to an ordinary task except the idle task. Further, the CPU register used by the task is not statically determined. Even in this case, the method described in the second embodiment maybe applied to the CPU register on which data maybe overwritten and the CPU register on which data must not be overwritten by leaving information in variables or the like in the processes of the task. Further, when a high-level language such as a C-language is used, the method described in the second embodiment may be applied in such a way that a compiler stores information related to the CPU register in variables or an SP difference information storing register provided in the CPU.

FIG. 13 shows a task controller of the present invention for realizing the above-described multitask system. The task controller of the present invention is different from the task controller in the first and second embodiments from the viewpoint that an SP difference information storing register 1300 is mounted. The SP difference information storing register 1300 is arbitrarily used. The address value for storing a final SP value upon operation of a task referred to in the step S502 can be previously calculated by the compiler and stored in the SP difference information storing register 1300. In such a manner, when an interrupt is received during the operation of an arbitrary task, the first address of a CPU register storage area in a task stack on which a stack for processing an interrupt is superimposed, which is previously supplied to an OS interrupt entry processing program or an interrupt control part 1211, and the value of the SP difference information storing register 1300 are calculated by an ALU 1204, and the calculated value is supplied to an external memory (RAM) 1214 via an operand address 1207 and a BCU 1212 as an address. Thus, the final value of an SP 1202 after the contents of the CPU register of the task in which the interrupt is generated are stored in the task stack can be written in the external memory (RAM) 1214 as operand data 1208. That is, the start address of the stack for processing the interrupt can be changed by an arbitrary value set to the SP difference information storing register 1300 by the compiler or the like. It is to be understood that a program such as an ordinary application except the compiler may set the value to the SP difference information storing register 1300. Hardware may set the value to the SP difference information storing register 1300. As a setting method, various kinds of methods may be employed without departing the principle of the present invention.

In the above-described embodiments, the examples in which the values of the PC and the PSW are stored on the task stack are explained. However, a register bank upon operation of a task and a register bank for processing an interrupt may be separately mounted depending on the kinds of CPUs. In such a CPU, upon receiving an interrupt, the values of the PC and the PSW are not stored on the task stack and may be copied in a storage area located in the register bank exclusively used for processing an interrupt. In this case, the values of the PC and the PSW stored in the register bank exclusively used for processing the interrupt are stored on the task stack in view of software, so that the same effects as those of the above-described embodiments can be obtained.

The memory managing system and the task controller in the multitask system according to the present invention employ the task stack areas and the interrupt stack area of the system using a real time OS in a duplicated manner. Accordingly, an available amount of memory may be reduced in the entire part of the system. Thus, the multitask system can be advantageously operated with the memory of small capacity. When the managing method of the stack memory of software, especially, the multitask system is executed, this system is effective as a program structure for reducing the available amount of the stack memory.

1. A method for managing stacks of a multitask system comprising the steps of:
storing an internal information of CPU in a task stack of a task to be interrupted as a first area in accordance with the generation of an interruption;
storing a value of a stack pointer after storing the internal information in a prescribed first position of an interrupt processing stack;
setting the stack pointer to a prescribed second position of the interrupt processing stack; and
starting an interrupt process,
wherein the prescribed second position of the interrupt processing stack corresponds to a prescribed position in the first area in the task stack of a specific task.

2. A method for managing stacks according to claim 1, wherein the first area includes a second area for storing task control information necessary for a return control from an interrupt process and a third area disposed immediately after the second area to store the internal information of the CPU except the task control information, and
the prescribed position in the first area in the task stack of the specific task corresponds to the top address of the third area in the first area.

3. A method for managing stacks according to claim 1, wherein the prescribed first position of the interrupt processing stack is the top address of the interrupt processing stack.

4. A method for managing stacks according to claim 1, wherein the prescribed second position of the interrupt processing stack is located immediately after the prescribed first position of the interrupt processing stack.

5. A method for managing stacks according to claim 1, wherein the first area includes a second area for storing task control information necessary for a return control from an interrupt process and a third area disposed immediately after the second area to store the internal information of the CPU except the task control information, and
the prescribed position in the first area in the task stack of the specific task is an address obtained by correcting the top address of the third area in the first area by a prescribed address difference value.

6. A method for managing stacks according to claim 5, wherein the address difference value is given to designate an area necessary for storing the internal information of the CPU used in the specific task.

7. A method for managing stacks according to claim 5, wherein the address difference value is previously given as a constant.

8. A method for managing stacks according to claim 5, wherein the address difference value is set by executing the specific task.

9. A method for managing stacks according to claim 2, wherein the task control information includes at least a program counter and a program status word (PSW) indicating the state of the CPU.

10. A method for managing stacks according to claim 1, wherein the specific task is an idle task which loops itself without using the internal information of the CPU.

11. A method for managing stacks according to claim 1, wherein the specific task is a task for controlling a shift and a return to a low power consumption mode.

12. A method for managing stacks according to claim 2, wherein no information is stored in the second area, the task control information and the internal information of the CPU located within a prescribed range are not stored in the task stack of the task to be interrupted but stored in a memory area different from the task stack and the internal information of the CPU except the internal information of the CPU located within the prescribed range is stored in the third area.

13. A stack controller of a multitask system in which information in a CPU is stored in the task stack of a task to be interrupted in accordance with the generation of an interrupt to have a first area, the value of a stack pointer after the storage in the first area is stored in a prescribed first position of an interrupt processing stack and the stack pointer is set to a prescribed second position of the interrupt processing stack to start an interrupt process, wherein a control mechanism is provided by which the top address of the interrupt processing stack is allowed to correspond to a prescribed position in the first area in the task stack of a specific task.

14. A stack controller according to claim 13, wherein the first area includes a second area for storing task control information necessary for a return control from an interrupt process and a third area disposed immediately after the second area to store the internal information of the CPU except the task control information, and the prescribed position in the first area in the task stack of the specific task corresponds to the first address of the third area in the first area.

15. A stack controller according to claim 13, wherein the first area includes a second area for storing task control information necessary for a return control from an interrupt process and a third area disposed immediately after the second area to store the internal information of the CPU except the task control information, and the prescribed position in the first area in the task stack of the specific task is an address obtained by correcting the first address of the third area in the first area by a prescribed address difference value.

16. A stack controller according to claim 15, wherein the address difference value is held in an address difference value storing unit showing an area necessary for storing the CPU information used in the specific task.

17. A stack controller according to claim 15, wherein the address difference value is previously given as a constant.

18. A stack controller according to claim 15, wherein the address difference value is set by executing the specific task.

19. A compiler for automatically forming the address difference value in the method for managing stacks according to claim 5.
